(19) United States
(12) Patent Application Publication
(10) Pub. No.: US 2005/0158503 A1
(43) Pub. Date: Jul. 21, 2005

(54) Outdoor adhesive mat with integral heating element

(75) Inventor: Lawrence J. O'Connor, Venice, FL (US)

Correspondence Address: ROBERTS, MLOTKOWSKI & HOBBES, P. O. BOX 10064, MCLEAN, VA, 22102, US

(73) Assignee: O'CONNOR INVESTMENT CORP., Winnipeg (CA)

(21) Appl. No.: 11/034,255

(22) Filed: Jan. 13, 2005

Related U.S. Application Data
(60) Provisional application No. 60/536,711, filed on Jan. 16, 2004.

(51) Int. Cl. B32B 9/00

(52) U.S. Cl. 428/40.1

(57) ABSTRACT

A covering is provided for exterior application on solid surfaces such as walkways, steps, decks, patios, and docks. The covering is formed of a top layer of fibrous material, such as carpet, a bottom layer of adhesive applied at a basis weight of between 185-1000 gsm, and a heating element sandwiched between. The heating element may be supported by an intermediate layer, such as rubber mat, or may be embedded into the adhesive. A control system may be provided for the heating element. A release sheet is secured over the adhesive for removal during installation. The covering can be sized for a step or a walkway.

### CROSS REFERENCE TO RELATED APPLICATIONS

This application claims priority from U.S. Provisional Application Ser. No. 60/536,711 filed Jan. 16, 2004. The contents of this application are incorporated herein by reference.

### STATEMENT REGARDING FEDERALLY SPONSORED RESEARCH OR DEVELOPMENT

[Not Applicable]

### REFERENCE TO A SEQUENCE LISTING

[Not Applicable]

### BACKGROUND OF THE INVENTION

1. Field of the Invention

This invention relates to surface coverings for exterior use. In particular, this invention relates to heated surface coverings used on steps, stairs, decks, patios and walkways.

2. Discussion of Related Art

Door mats are commonly used on stoops to provide a surface at the threshold of an entrance to wipe one's feet. However, most door mats are generally not permanently affixed to a surface. Typically, they are merely placed on the surface or, at most, have a rubber bottom which provides a friction grip onto the surface.

It is also known to provide coverings, such as indoor/outdoor carpet, on walkways or steps to provide traction on potentially slippery surfaces. Coverings may also be used to refurbish a worn exterior surface rather than full replacement. Again due to the difficulty in affixing coverings to exterior surfaces exposed to the elements, most coverings are merely laid over the surface or tacked in place.

In areas with harsh climates, heated mats are sometimes used to provide a snow or ice free surface. These mats are typically laid on the ground and provide a walkway surface, door mat or driveway surface. Heat can be provided by electrical resistance type heaters connected to the mats. The problem with these known types of mats are that they must be put in place prior to a storm or prior to snow or ice accumulation. Also, as the mats are typically merely laid in place, they are prone to shifting and wrinkling. The exposed edges can also create a raised edge or tripping hazard.

There is a need for a covering product that is easy to install, is highly durable and can remain securely fastened in place while providing a heated surface.

### BRIEF SUMMARY OF THE INVENTION

Aspects of embodiments of the invention relate to a product that provides a durable covering for exterior surfaces.

Another aspect of embodiments of the invention relates to a product that is easy to install and remains securely fastened to an underlying surface.

A further aspect of embodiments of the invention relates to a product that offers a selectively controlled heated surface for melting ice and snow.

This invention is directed to fibrous covering for outdoor use having an adhesive coating on the underside for permanent adhesion to an exterior surface and an integral heating element that may be selectively actuated. The covering may have a release sheet removably affixed to the adhesive underside for easy installation on site. The exterior surface can be a wood or synthetic surface, such as on a deck, or a concrete surface, such as a patio, stoop, walkway, driveway or garage floor. It is contemplated that this covering can be applied to most solid exterior surfaces.

One aspect of the invention is directed to a covering to be installed on an exterior surface, comprising a fibrous layer having a top fibrous surface and a bottom surface, a heating element supported by an intermediate layer secured to the bottom surface of the fibrous layer, an adhesive layer applied to the intermediate layer under the heating element, and a release sheet removably secured to the adhesive layer.

The invention is also directed to a covering for outdoor use, comprising a carpet layer having a top fibrous surface and a bottom surface, a heating element connectable to a power source secured to the carpet layer, an adhesive layer applied to substantially the entire bottom surface of the carpet layer to secure the heating element between the carpet layer and the adhesive layer, wherein the adhesive layer is applied at a basis weight of between 185 and 1000 gsm, and a release sheet removably secured to the adhesive layer for selective removal upon installation of the covering.

The fibrous layer may include a mix of low melt polyethylene fibers dispersed within polypropylene fibers.

The heating element may be any known type of heating element, such as an electric resistance heating element in the form of a wire or a mesh.

The adhesive may be a pressure sensitive adhesive.

The adhesive may be applied at a basis weight of between 185-1000 gsm. Preferably, the adhesive is applied at a basis weight of between 300-1000 gsm.

The adhesive may applied at a thickness of between 5-30 mils. Preferably, the adhesive is applied at a thickness of between 15-30 mils.

The release sheet may cover substantially the entire adhesive layer.

The covering may be sized for a step. The covering may be sized for a standard stair tread. The covering may be sized for a walkway or any other pedestrian traveled surface.

These and other aspects of the invention will become apparent when taken in conjunction with the detailed description and appended drawings.

### BRIEF DESCRIPTION OF THE DRAWINGS

The invention will now be described in conjunction with the accompanying drawings in which:

FIG. 1 is front schematic view of an exterior stoop with the covering in accordance with an embodiment of this invention applied to the surface of steps and to the walkway;

FIG. 2 is an enlarged side view in cross section of a covering in accordance with the invention before installation;

FIG. 3 is a plan view of a heating component usable in an embodiment of the invention;

FIG. 4 is a plan view of a heating component usable in an embodiment of the invention;

FIG. 5 is a side view in partial cross section of a covering in accordance with an embodiment of the invention in which the heating element is retained in a beveled mat; and

FIG. 6 is a side view in perspective of the beveled mat of FIG. 5.

In the drawings, like reference numerals indicate corresponding parts in the different figures.

### DETAILED DESCRIPTION OF PREFERRED EMBODIMENTS

This invention is directed to a surface covering in the form of a strip or mat particularly suited for covering a stoop, walkway or steps in an exterior environment or an environment subject to exposure to the elements. The invention is particularly suited for covering steps of typical exterior material, including boards or concrete. These materials tend to have irregular surfaces. For example, boards can exhibit warping and irregularities along their length, and concrete can have cavities, rough aggregate and cracks. The invention may also be used on plastic or plastic composite boards to provide a non-slip surface.

Accordingly, this invention may be used on walkways, driveways, decks, docks, porches, patios, stoops, or other such surfaces. For purposes of simplicity, the surface used herein is intended to refer to any type of exterior structural surface.

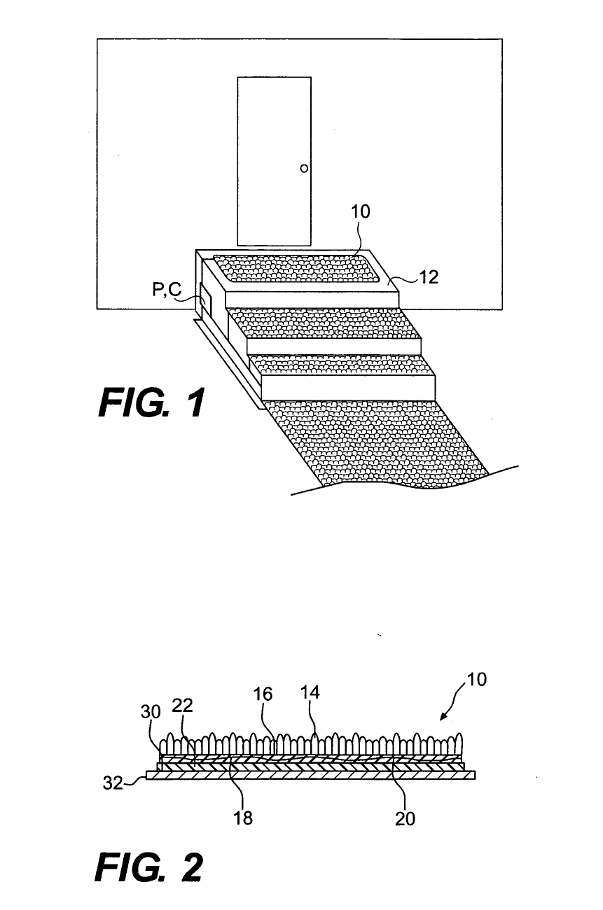

Referring to FIG. 1, a covering 10 is applied to an exterior surface 12, such as a stoop and walkway. The covering 10 is formed as a mat that is permanently affixed to the surface 12. As can be appreciated, the covering 10 can be formed in any size, such as an entrance mat, a stair tread, a length for a walkway or thin strip for a deck board, for example.

FIG. 2 shows an enlarged view of covering 10 prior to being secured to step 12. Covering 10 has a top layer 14 preferably made of a fibrous material, such as carpet material, which provides a top surface with good traction and appearance. A desirable weight of fibers would fall within the range 18-60 ounces per square yard, depending on the particular use and expected traffic. For example, a desirable weight of fibers for a deck may be 18 ounces per square yard, while the desirable weight for a step may be 28 ounces per square yard.

Preferably, the top layer 14 of carpet material is formed as a mix of low melt polyethylene fibers dispersed within polypropylene carpet fibers. The dispersal of these fibers results in a firmer, more stable structure. Due to the improved structure, it is not necessary to use a backing, such as latex as is commonly used. The problem with latex backings in a wet environment is that the foaming agent used during manufacturing becomes reactivated when wet, which causes the material to become slippery. The fiber mix may include UV treated materials to offer increased durability for installations exposed to sunlight.

The top layer 14 is preferably adhered by an adhesive layer 16 to a intermediate layer 18 that includes a heating element 20. The intermediate layer 18 can be, for example, a rubber layer. Alternative materials could be foil, EVA film, or a closed cell foam. These materials would provide a tensile strength or barrier layer if desired in the particular design. It is preferred that the intermediate layer 18 not be formed of a porous material, such open cell foam, as is common in interior carpeting, as this tends to become water logged and would disintegrate upon exposure to the elements. It is preferred that the intermediate layer 18 be substantially hydrophobic and moisture resistant as the invention is intended for exterior use and therefore will be exposed to moist environments. It is additionally preferred that the intermediate layer 18 be formed of a flexible material so that the heating element 20 can flex when pressure is applied to the covering 10. It is also possible to dispense with an intermediate layer, as discussed below.

The underside of the intermediate layer 18 is coated with a thick layer of adhesive 22. Alternatively, the adhesive 22 can be coated directly onto the backside of the fibrous material 14 to form an integral structure. The adhesive 22 is preferably water insoluble to resist deterioration due to the elements. The adhesive layer 22 is preferably made of a pressure sensitive adhesive (PSA) that is a hot melt, meaning it is applied at 100% solids. Suitable adhesive compositions are available from many different manufacturers and can be used as a hot melt adhesive. The application techniques can vary depending on the particular adhesive composition, but one effective method is for the adhesive to be die coated and, if desired, treated with pressure and/or vacuum to enhance physical penetration of the adjacent layer. Other suitable methods known to those of ordinary skill in the art are also possible, such as spraying, extrusion, or other methods of coating. It is preferred that hydrophobic adhesive be used to prevent water contaminating the bond between the adhesive and underlying surface.

The viscosity of the adhesive material 22 may also be varied to affect penetration or wetting into the surface 12. Lowering the viscosity, increases the wetability (tack) of the adhesive, thereby allowing it to penetrate deeper into the surface 12. As would be appreciated by those of ordinary skill with adhesives, the density of the adhesive will affect the coating weight. The adhesive material functions as a waterproof layer based on its composition and/or thickness. It is preferred that the material be free of voids.

As noted above, in this invention, the adhesive 22 is applied as a thick layer. The minimum thickness of the adhesive 22 measured to its bottom surface is preferably at least 5 mils so as to provide sufficient thickness of adhesive material to obtain complete coverage to allow molding of the covering 10 to the exposed surface 12. The range of preferred thickness of the adhesive 22 is between about 5 mils and 30 mils, more preferably 15 mils-30 mils. Another method of measuring the adhesive 22 is the applied basis weight, coating weight or amount, as the ultimate thickness can vary depending upon application techniques. The preferred coating weight or amount of adhesive material is at least about 185 gsm, preferably in a range of approximately 185-1000 gsm. These values are based on use of a PSA.

It is contemplated that with different adhesive materials, application techniques, and environments that different volumes, coating weights, or amounts could be successfully used as long as the resultant layer of material has the ability to mold to the irregular surface of the underlying surface to form a permanent bond. For example, it is contemplated that a coating weight of about 100 gsm given the appropriate material could be used, especially in climates that do not experience freeze/thaw cycles. It is also contemplated that in certain applications, strips of moldable material may be used rather than a solid layer.

As a result of the thickness and viscosity, the adhesive 22 also conforms to the surface and forms a mechanical interlock with the underlying surface. This interlock creates a permanent bond that stands up to the exterior elements and forms a very secure bond. This is particularly applicable when used on traditional exterior structural elements such as concrete and wood, which have irregular or non-smooth surfaces. On such surfaces, if the adhesive layer is thin, moisture can penetrate between the adhesive and the surface comprising the connection. Using a thick layer creates the mechanical connection that prevents moisture from penetrating and ensures a secure connection that will be highly durable.

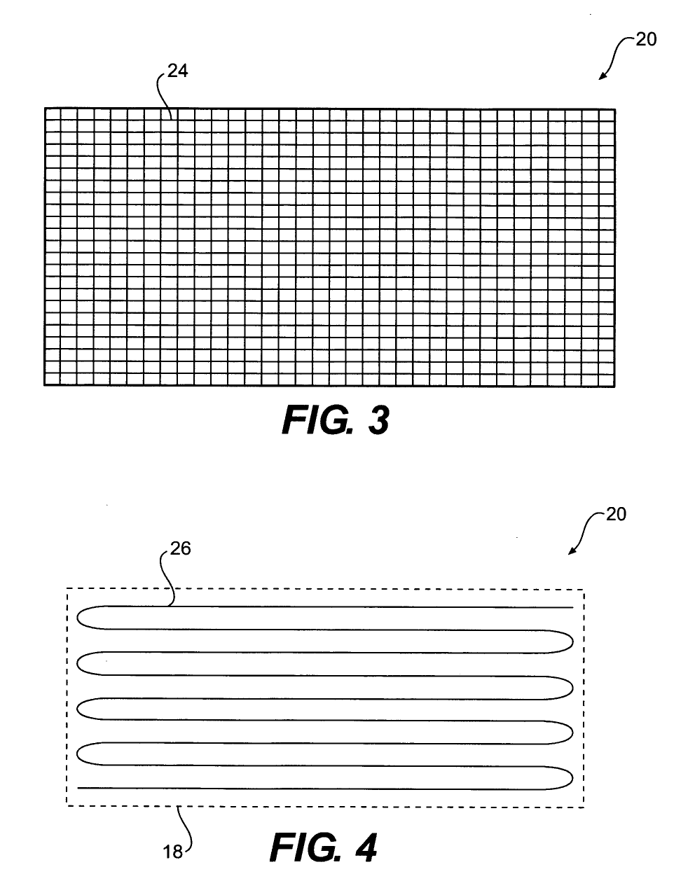

Referring back to the heating element 20, FIGS. 3 and 4 show two possible forms of the heating element 20. In FIG. 3, the element is formed as a conductive mesh 24 that may be embedded in the intermediate layer 18 or directly into the adhesive 22. In either event, the mesh 24 is sandwiched between the adhesive layer 22 and the fibrous layer 14.

FIG. 4 shows a resistive heating wire or cable 26 that can be embedded in the intermediate layer 18 or directly into the adhesive 22. Any known heating element 20 may be used that is suitable for exterior use. The heating element 20 is connectable to a power source P, such as an electric outlet or a battery. The heating element 20 may be adapted for use with an AC or DC current, depending on the desired use.

A control system C may also be provided with the heating element in order to automatically actuate the heating element, based on sensed weather conditions or based on time. The weather conditions may relate to the temperature, the amount of snow and/or the wind in order to properly heat the ground surface in the most efficient and effective manner. A thermostat may also be provided in each mat to control the temperature of the covering 10 and ensure that the heating element 20 is properly actuated and controlled.

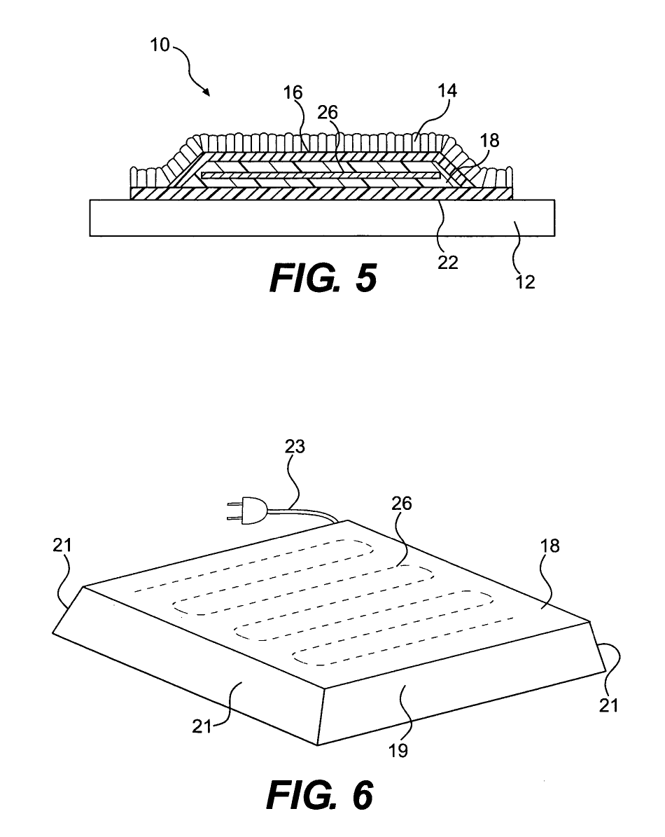

FIG. 5 shows a preferred embodiment of the covering 10 in which the intermediate layer 18 is formed as a rubber mat about ⅜ inch thick with three beveled edges. The heating element is formed as electric resistance cable 26 embedded in the rubber mat. As seen in FIG. 6, the front edge 19 of the intermediate layer 18 is a 90° edge that is intended to be positioned at the leading edge of step. The other three edges 21 are beveled at an angle, in this case about 45°. Of course, other configurations of the layer 18 can be used, for example with different angles or rounded edges. The fibrous layer 14 entirely covers the intermediate layer 18 and is sealed to the adhesive layer 22. An electric cable and plug 23 connect to the cable 26, which is grounded, and extend from the back of the covering 10. The spacing and number of turns of the cable 26 affects the power of the heating system, measured as wattage density. In this case, for example, the covering 10 has a heating power of 35 watts per foot. It is contemplated that the range of watts per foot could be from 12 watts per foot to 250 watts per foot, preferably from 12 watts per foot to 150 watts per foot.

The adhesive layer 22 can also be provided with a side bead that functions as an integral gasket on the edge of the covering 10. When the covering 10 is pressed onto the surface 12, the bead will tend to flatten and act as a gasket ensuring that no moisture can penetrate the edges of the seal. The bead allows a complete coating of adhesive to be realized under the top layer 14 by spreading to the edges of the top layer 14. Of course, any or all of the edges of the covering 10 may be provided with beads.

FIG. 2 illustrates the covering 10 in a preassembled condition, such as during packaging, transport, storage or display. In this condition, the covering 10 has a release sheet 30 that is releasably applied over the adhesive layer 22. The release sheet 30 is removed during installation and discarded. If desired, the release sheet 30 may carry instructions, measurements, indicia relating to the direction of pile and other printed information. Preferably, the release sheet 30 extends beyond the edges of the covering to form flaps 32 that act as a gripping surface to facilitate removal during installation. The release sheet 30 may be applied as a single sheet or multiple sheets depending on the size of the covering piece.

The release sheet 30, which is also called a release liner, can be formed of any releasable sheet material that is easily pulled from the bottom surface of the adhesive 22. A suitable material is silicone coated polyester film. However, other materials may be used, including films such as high density polyethylene, polypropylene, polyolefin, or silicon coated paper. A preferred material is a silicone coated polyester sheet about 1-2 mils thick. The important features of the sheet 30 are that it releases reliably from the adhesive surface and avoids tearing so that it is easy for an installer to use.

As noted above, the covering 10 can be provided in any size. For example, covering 10 can be formed in a mat size, which would be held securely in place to minimize the danger of tripping and provides no obstacles when shoveling snow. The covering 10 can also be provided in the general size of a step. For example, for use on a step made of boards, a covering 10 would be made the size of the tread. The covering 10 can be precut to 3 foot or 4 foot lengths for standard steps or 3 foot widths with selective lengths for a walkway. Cutting can be accomplished with a laser for example.

Standard sizes can be prepackaged and simply installed on a step or stoop by a homeowner with no further customization. The release sheet is merely peeled away and the strip placed on the surface. The covering 10 is then attached to a power source for selective activation. If desired, the release sheet may have a separable positioning strip to expose a narrow band of adhesive to position and tack the covering in place before the covering is completely applied to the surface. By this, an attractive covering 10 with a durable yet high traction surface is provided securely fastened to a desired exterior surface such as steps or a walkway. During inclement weather or for winter seasons, the heating element 20 can be activated to prevent ice and snow from accumulating on the covering 10.

It is also possible to provide the covering 10 in a roll, either a pancake roll or traverse wound roll for ease of transport and supply. In that configuration, standard display racks in home improvement retail centers could be used for display and supply.

Various modifications can be made in my invention as described herein, and many different embodiments of the device and method can be made while remaining within the spirit and scope of the invention as defined in the claims without departing from such spirit and scope. It is intended that all matter contained in the accompanying specification shall be interpreted as illustrative only and not in a limiting sense.

1. A covering to be installed on an exterior surface, comprising:
a fibrous layer having a top fibrous surface and a bottom surface;
a heating element supported by an intermediate layer secured to the bottom surface of the fibrous layer;
an adhesive layer applied to the intermediate layer under the heating element; and
a release sheet removably secured to the adhesive layer.

2. The covering of claim 1, wherein the intermediate layer is a rubber mat.

3. The covering of claim 1, wherein the fibrous layer includes a mix of low melt polyethylene fibers dispersed within polypropylene fibers.

4. The covering of claim 1, wherein the adhesive layer is a pressure sensitive adhesive.

5. The covering of claim 4, wherein the intermediate layer is encapsulated between the fibrous layer and the adhesive layer.

6. The covering of claim 1, wherein the adhesive layer is applied at a basis weight of between 185-1000 gsm.

7. The covering of claim 1, wherein the adhesive layer is applied at a basis weight of between 300-1000 gsm.

8. The covering of claim 1, wherein the adhesive layer is applied at a thickness of between 5-30 mils.

9. The covering of claim 1, wherein the adhesive layer is applied at a thickness of between 15-30 mils.

10. The covering of claim 1, wherein the release sheet covers substantially the entire adhesive layer.

11. The covering of claim 1, wherein the covering is sized for a step.

12. The covering of claim 1, wherein the heating element is connectable to a power source.

13. The covering of claim 1, wherein the heating element is a conductive mesh.

14. The covering of claim 1, wherein the heating element is a resistive heating cable.

15. The covering of claim 1, further comprising a control system connected to the heating element to selectively control actuation of the heating element.

16. The covering of claim 15, wherein the control system actuates the heating element based on sensed weather conditions.

17. A covering for outdoor use, comprising:
a carpet layer having a top fibrous surface and a bottom surface;
a heating element connectable to a power source secured to the carpet layer;
an adhesive layer applied to substantially the entire bottom surface of the carpet layer to secure the heating element between the carpet layer and the adhesive layer, wherein the adhesive layer is applied at a basis weight of between 185 and 1000 gsm; and,
a release sheet removably secured to the adhesive layer for selective removal upon installation of the covering.

18. The covering of claim 17, wherein the carpet layer includes a mix of low melt polyethylene fibers dispersed within polypropylene fibers.

19. The covering of claim 17, wherein the adhesive layer is formed of a pressure sensitive adhesive.

20. The covering of claim 17, wherein the heating element is supported by an intermediate layer secured between the carpet layer and the adhesive layer.
